(19) United States
(12) Patent Application Publication
(10) Pub. No.: US 2011/0203078 A1
(43) Pub. Date: Aug. 25, 2011

(54) Grab Bar

(76) Inventor: David L. Farrow, SR., Castle Hayne, NC (US)

(21) Appl. No.: 13/100,597

(22) Filed: May 4, 2011

Related U.S. Application Data
(63) Continuation-in-part of application No. 11/677,526, filed on Feb. 21, 2007, now abandoned.
Application No. 11/677,526 is a continuation-in-part of application No. 10/940,188, filed on Sep. 14, 2004, now abandoned.

(51) Int. Cl. B25G 1/04

(52) U.S. Cl. 16/429

(57) ABSTRACT

A load bearing grab bar to be used in public and household restrooms to aid elderly or handicapped people in lowering or raising themselves from a toilet or wheelchair. The grab bar attaches to an existing handrail, and has an adjustable support leg that attaches to a wall or floor to provide better stability when weight is applied. The grab bar rotates from a vertical stored position to a horizontal in-use position to allow for better and safer mobility around a home bathroom or public toilet stall.

This is a continuation-in-part of application Ser. No. 11/677,526 filed on Feb. 21, 2007, which was a continuation-in-part of application Ser. No. 10/940,188 filed on Sep. 14, 2004, and priority is claimed thereto.

### FIELD OF THE INVENTION

The present invention relates to a grab bar apparatus that may be used to enable an individual to improve his or her balance and positioning when transferring from a toilet seat or a wheelchair to a standing position. More particularly it is a grab bar that is foldable, secure, improves safety when transferring in the bathroom, and helps users to regain/maintain their independence.

### BACKGROUND OF THE INVENTION

Severe accidents often occur in the bathroom in a residential home or public restroom. The reason for this is that many bathroom items, such as bathtubs, toilets, and floors, are made out of smooth solid material, such as porcelain, tile, marble, and metal. Complicating matters further, these materials have a tendency of becoming slippery when wet. This factor proposes a dangerous threat to bathroom users, as slipping on such surfaces can result in serious physical injury. For the disabled, elderly, and young children the risk of serious injury increases, whether or not surfaces in the bathroom are wet. A main problem for such persons, especially the elderly and disabled, becomes using the bathroom. This problem is particularly cumbersome for those frail persons residing in their own residential homes and not getting in-depth care or assistance, such as the care provided in a hospital or by a full-time nurse. Such persons are by and large capable of caring for themselves but are still fairly weak, thus simple tasks like using the bathroom become greatly burdensome.

In an attempt to lower the risk of injury in the bathroom and aid users with disabilities, an assortment of grab rails have become widespread in bathroom facilities. Handrails are mounted on the walls adjacent to toilets to provide a source of support, which a person can utilize to get into standing or sitting position. A popular form of handrail is the conventional straight grab bar, which is a stationary fixed rail bolted or otherwise attached to a wall that allows a user to grab with his or her hands in order to aid in the transition between a seated and standing position. Yet such devices are often made of rigid material that employ a tubular rail with a large diameter along the length. This configuration provides complications for people with small or frail hands who cannot grab the handrail securely, and thus the handrail becomes useless for such users and the danger of serious injury remains present.

Swing away grab bars are of a triangular configuration and mount to the wall and floor. These devices pivot away from the wall, and snap, lock, or drop into place. Yet unlike the present invention, such devices can become obstructive and hinder movement of the user, as they do not allow for enough legroom if the user wears a leg brace or cast.

U.S. Pat. No. 5,690,237 issued to Richard E. Marzee on Nov. 25, 1997 and U.S. Pat. No. 6,112,344 issued to Torbett B. Guenther on Sep. 5, 2000, both show forms of conventional straight grab bars that are mounted on the wall, yet unlike the present invention these devices are mounted a small distance off the wall, thus making them difficult for the user to reach, and limiting the user's ability to obtain a strong two-handed grasp. Also, given that that these devices require users to push themselves up, which requires more upper body strength as compared with pulling with both hands, these devices may cause strain or stress in the wrists of the user when he or she moves onto or off a toilet seat as well as in or out of a wheelchair. These forms of handrails do not provide adequate assistance in maneuvering in a bathroom stall.

U.S. Pat. No. 6,131,213 issued to Lawrence L. Sarff on Oct. 17, 2000 shows a U-shaped wall mounted hand rail, which flips down and locks in place, yet unlike the present invention this device does not allow for excessive weight bearing down. The amount of weight bearing capacity is wholly dependent upon the construction of the wall it is installed on. If mounted on a side wall, the apparatus does not extend far enough in front of a user to offer enough leverage. If installed on a facing wall, this device will only be functional if the facing wall is in close enough proximity to the toilet to be of assistance.

U.S. Pat. No. 5,590,440 issued to Thomas E. Pelt on Jan. 7, 1997 shows a grab bar assembly consisting of an elongated D-shaped bar, wall mounted, which folds up against the wall when not in use. Yet unlike the present invention, this device has a small mounting base, which does not allow for a great deal of force to be used in pulling the user from the toilet or a wheelchair, or in weight bearing down upon the device. This device could also be pulled from the wall quite easily. Another limitation of the device not present in the present invention is that when flipped into a storage mode, the device extends into the walkway and hinders movement of the user. Furthermore, the bottom support arm of the device poses an injury risk should a user lose his or her balance and fall on the sharp bottom edge.

U.S. Pat. No. 3,414,904 issued to Mike A. Provi on Dec. 10, 1968, U.S. Pat. No. 4,417,361 issued to Alfred A. Smith on Nov. 29, 1983, U.S. Pat. No. 5,050,252 issued to Rik Cuttriss on Sep. 24, 1991, U.S. Pat. No. 5,105,483 issued to Robin Levien on Apr. 21, 1992, and U.S. Pat. No. 5,659,904 issued to Paul J. Doczy on Aug. 26, 1997, show safety handrails. Yet unlike the present invention, these devices are configured for bathtubs and Jacuzzis and therefore would not provide any assistance for a user on a toilet seat.

Thus there is a need for a handrail that provides a solid, secure lever that can withstand the forces of both pushing and pulling, and is convenient and efficient to use, in order to aid a user in sitting and standing.

### SUMMARY OF THE INVENTION

The present invention improves upon the various previous methods, to include cited patents, of assisting a user in moving between a toilet seat and standing stance. The present invention is efficient to use, convenient, space saving, and doesn't hinder the movement of the user.

The present invention has three main bars. A first bar connects to an existing conventional hand bar so that it can rotate roughly 90 degrees about the conventional hand bar. In use, the first bar rotates from a position where it is nearly parallel to a vertical wall to a position relatively perpendicular to a vertical wall. In an alternative embodiment, the first bar may be designed in an angled or curved configuration, as opposed to being straight, to provide a better grip for the user. A second bar mounts to a conventional floor, wall, or other fixed surface. The second bar is relatively parallel to a vertical wall when the present invention is not deployed, and shifts to an angle (preferably about 10 degrees) from the vertical wall when deployed. The second bar also features a height adjustment component that allows the user to adjust the second bar to a desired height. A third bar is connected at a first end to the first bar, and at a second end to the second bar. When the present invention is deployed, the third bar moves roughly 90 degrees in order to lock the first bar into place.

In order to deploy the present invention, the user raises the grip bar from its stored position until the grip bar arm locks in the horizontal position. The grip bar arm then acts as a secured lever that can withstand the forces of pulling and pushing, in order to aid the user in standing up or sitting down. When the present invention is raised into a horizontal position for use, it engages the second bar, which is connected to the first bar via the third bar and can be adjusted to a desired height in order to provide optimum support and comfort for the user. Such a configuration allows the user to bear weight on the first bar, the first bar then transferring the weight to the second bar safely and securely. As the first bar is raised to the deployed position, a cylinder attached to the third bar pivots and slips down upon a collar that is a partial cylinder mounted at the first end of the third bar. This action locks the first bar into place.

After the user is finished using the present invention, the first bar is lowered by removing the cylinder from the collar so that the cylinder no longer is frictionally engaged with the high point of the collar. Thus the third bar pivots down back to its original position, pivoting on both the first pin and the second pin. The present invention folds down neatly out of the way, the first bar rotating about the conventional hand bar to move from a horizontal position to a nearly vertical position, and the second bar shifting from its deployed roughly ten degree angle from the vertical position to a nearly vertical position beside the wall. The device will stay in place folded down against the wall until it is used again.

### BRIEF DESCRIPTION OF THE DRAWINGS

FIG. 1 shows a side view of the present invention from the perspective of a user sitting on a conventional toilet or wheelchair.

FIG. 2 focuses on the parts between the engagement piece (70) and the release plug (135).

FIG. 3 shows a top view of the present invention.

### DETAILED DESCRIPTION OF THE PRESENT INVENTION

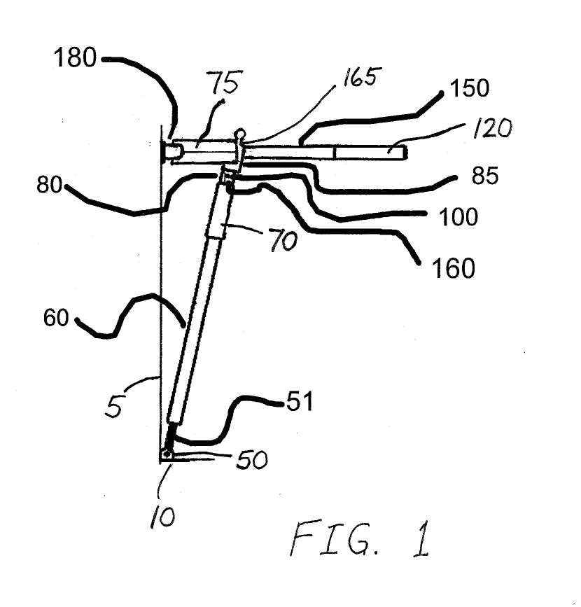

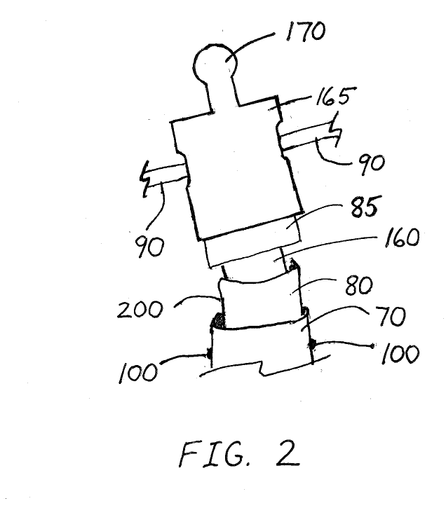

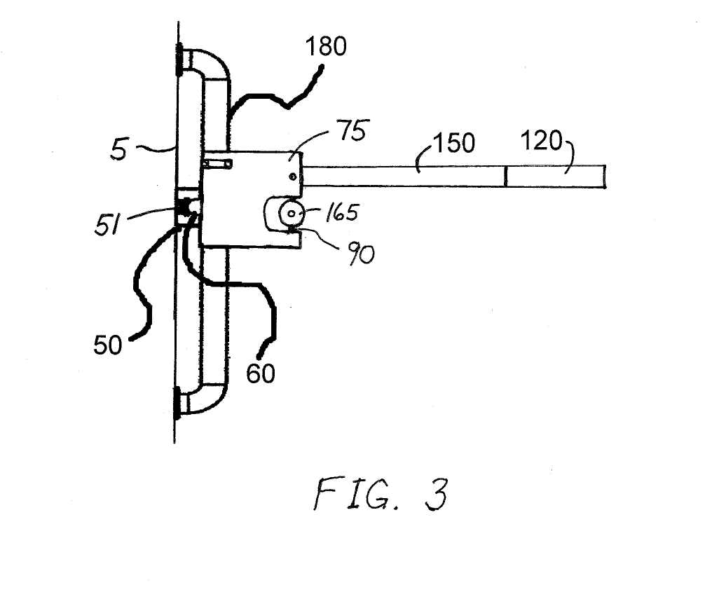

The present invention is a grab bar apparatus to help enable an individual to improve his or her balance, positioning, and weight bearing status when transferring from a toilet seat or a wheelchair to a standing position. To accomplish this goal, it is configured for a vertical pivoting movement between a lowered, stored position against a wall (5) and a raised, horizontal in-use position. FIG. 1 shows a side view of the present invention in the raised, in-use position. Examining the present invention as shown in FIG. 1 from base to summit, at the base of the present invention is the foot mount (50) that anchors the present invention to a floor (10) or wall (5). The preferred embodiment of the present invention envisions the foot mount (50) attached to the wall (5) by conventional means such as screws or bolts. Above the foot mount (50) is a conventional height-adjustment component (51) that permits the user to raise or lower the present invention to an optimal height. Above the height-adjustment component (51) is the second bar (60). When the present invention is deployed, the position of the second bar (60) shifts from its position relatively parallel to the wall (5) to an angle of about ten degrees, as shown in FIG. 1. Above the second bar (60), near the summit of the present invention, are an engagement piece (70), third bar (160), second pin (100), collar (80), cylinder (85) attached to a release plug (165), and a first bar (150). The first bar (150) connects to the third bar (160) by means of a first pin (90) (not visible in FIG. 1, see FIG. 2 or FIG. 3), and the third bar (160) connects to the second bar (60) via the second pin (100). On one end of the first bar (150) is placed an end cap (120) made of rubber or other material that permits the user to get a good grip on the first bar (150) as the user attempts to lift up himself or herself. At the other end of the first bar (150), the first bar (150) is bolted into a plate (75), which in turn is connected to a conventional hand bar (180). The plate (75) is envisioned in the preferred embodiment as in a rectangle shape, and made of two halves of Teflon-impregnated hardcoat-anodized aluminum that enclose and attach to the conventional hand bar (180), the first bar (150), and the first pin (90) (not visible in FIG. 1, see FIG. 2 or FIG. 3).

When the present invention is deployed, at the same time that the first bar (150) raises from a position relatively parallel to the wall (5) to a position relatively perpendicular to the wall (5), the second bar (60) shifts to an approximately ten degree angle, as shown in FIG. 1. When the first bar (150) is raised to a horizontal deployed position, the second bar (60) is a stabilizing element of the present invention through its attachment to the wall (5) or floor (10) via the foot mount (50). Because the second bar (60) is the stabilizing force, the first bar (150) is capable of accepting the force and weight of the user as he or she attempts to rise from a seated position. The weight from the first bar (150) is transferred to the second bar (60) to provide the safest and most efficient use of the present invention. The third bar (160), which connects to an end of the first bar (150) and also to an end of the second bar (60), is explained below.

As shown in FIG. 1, the third bar (160) is connected to both the first bar (150) and the second bar (60). The significance of the movement of the third bar (160) is that it allows the first bar (150) to move from a vertical position to a locked horizontal position. When the first bar (150) is lifted, the end of the third bar (160) attached to the first pin (90) (not visible in FIG. 1, see FIG. 2 or FIG. 3) is lifted too, as is the cylinder (85) connected to both the third bar (160) and the first pin (90) (not visible in FIG. 1, see FIG. 2 or FIG. 3). The third bar (160) and the cylinder (85) thus rotate about 90 degrees pivoting on the second pin (100) until the cylinder (85) slips down over and covers the collar (80), which is a partial cylinder connected to the engagement piece (70) and the second bar (60). It should be understood that cylinder (85) circumscribes third bar (160). When the cylinder (85) slips down over the collar (80), the first bar (150) will be locked in an upright position and supported by the second bar (60). This action of the cylinder (85) slipping down over the collar (80) is shown in detail in FIG. 2.

Many of the elements that actually make up the movement of the present invention can be seen in FIG. 2, which shows the parts located between the engagement piece (70) and the first pin (90). Examining FIG. 2 from base to summit, there is the engagement piece (70), second pin (100), collar (80) with curved sidewall (200), third bar (160), cylinder (85), first pin (90), release plug (165), and release knob (170). When the present invention is deployed by lifting the first bar (150), a number of events occur. The third bar (160), which is attached at opposite ends to both the first pin (90) and the second pin (100), is lifted by the first pin (90) and pivots on the second pin (100) so that the release plug (165) and its attached cylinder (85) are inverted and the cylinder (85) slips over the collar (80). When the cylinder (85) slips over the collar (80), the present invention is locked in place. When the user wishes to disengage the present invention, then the user pulls the release knob (170) on the release plug (165) so that the cylinder (85) is removed from the collar (80). The third bar (160) then moves back to its disengaged position, the third bar (160) pivoting on the second pin (100), and the release plug (165) and its attached cylinder (85) coming to rest on the first pin (90).

FIG. 3 shows us the present invention in a view from above. From this angle, one can see the first bar (150) with its end cap (120). The first bar (150) is bolted to the plate (75), which fits onto the conventional hand bar (180) attached to the wall (5). Also visible in this view are the release plug (165), first pin (90), a small portion of the second bar (60), a small portion of the height adjustment component (51), and the foot mount (50).

In summary, the present invention is a grab bar comprising a first bar (150), a third bar (160) in communication with the first bar (150), the third bar (160) capable of rotating 90 degrees, a cylinder (85) circumscribing the third bar (160), the cylinder (85) positioned below a release plug (165), a collar (80) covered by the cylinder (85) to hold the first bar (150) in a raised position, and a second bar (60) in communication with and under the third bar (160). The present invention further comprises a release knob (170) on top of the release plug (165), a plate (75) mounted on a hand bar (180) with the plate (75) attached to the first bar (150), a first pin (90) connected to the third bar (160), the first pin (90) connected to the plate (75), the plate (75) mounted on a hand bar (180), the plate (75) attached to the first bar (150), the first pin (90) connected to the third bar (160), and a second pin (100) connected to the second bar (60) and the third bar (160).

Having illustrated the present invention, it should be understood that various adjustments and versions might be implemented without venturing away from the essence of the present invention. The present invention is not limited to the embodiments described above, and should be interpreted as any and all embodiments within the scope of the following claims.

I claim:

1. A grab bar comprising:
a first bar;
a third bar in communication with said first bar, said third bar capable of rotating 90 degrees;
a cylinder circumscribing said third bar, said cylinder positioned below a release plug;
a collar, covered by said cylinder to hold said first bar in a raised position; and
a second bar in communication with and under said third bar.

2. The grab bar of claim 1, further comprising a release knob on top of said release plug.

3. The grab bar of claim 1, further comprising a plate mounted on a hand bar, said plate attached to said first bar.

4. The grab bar of claim 1, further comprising a first pin connected to said third bar.

5. The grab bar of claim 1, further comprising a first pin connected to a plate.

6. The grab bar of claim 2, further comprising a plate mounted on a hand bar, said plate attached to said first bar.

7. The grab bar of claim 2, further comprising a first pin connected to said third bar.

8. The grab bar of claim 2, further comprising a first pin connected to a plate.

9. The grab bar of claim 3, further comprising a first pin connected to said third bar.

10. The grab bar of claim 3, further comprising a first pin connected to said plate.

11. The grab bar of claim 4, further comprising said first pin connected to a plate.

12. The grab bar of claim 1, further comprising a second pin connected to said second bar and said third bar.
